(19) United States
(12) Patent Application Publication
(10) Pub. No.: US 2011/0078424 A1
(43) Pub. Date: Mar. 31, 2011

(54) OPTIMIZING PROGRAM CODE USING BRANCH ELIMINATION

(75) Inventors: Omer Yehuda Boehm, Haifa (IL); Gad Haber, Haifa (IL); Yousef Shajrawi, Haifa (IL)

(73) Assignee: International Business Machines Corporation, Armonk, NY (US)

(21) Appl. No.: 12/570,318

(22) Filed: Sep. 30, 2009

(51) Int. Cl. G06F 9/38; G06F 9/45

(52) U.S. Cl. 712/234; 712/E09.045; 717/151

(57) ABSTRACT

A method for optimizing program code is provided. The method comprises detecting a branch instruction comprising a condition expression, wherein the branch instruction, when executed by a processor, causes the processor to execute either a first set of instructions or a second set of instructions according to a value of the condition expression; and replacing the branch instruction with a third set of instructions that are non-branching, wherein the third set of instructions, when executed by a processor, has a collective effect same as if either the first or second set of instructions were executed according to the value of the condition expression. The third set of instructions comprises a negation instruction to normalize the value of the condition expression.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of the claimed subject matter to material associated with such marks.

### TECHNICAL FIELD

The claimed subject matter relates generally to program code optimization and, more particularly, to branch elimination in a program code.

### BACKGROUND

The source code of a program may comprise a branch instruction. The branch instruction generally includes a condition expression that is evaluated to return either a “true” or a “false” value. The return value may be represented as a sequence of bits (i.e., a sequence of 0s and 1s). Typically, a bit sequence in which each bit is equal to zero (e.g., 00000) is a “false” value, and any other bit sequence is a “true” value.

The value of the condition expression is used to determine whether the program is executed according to a first control path (i.e., a first set of instructions) or a second control path (i.e., a second set of instructions). For example, if the value is “true,” the program is executed according to the first control path; if the value is “false,” the program is executed according to the second control path.

Execution performance of a program code may be optimized if branching instructions are reduced or eliminated. Improved systems and methods are needed for replacing a branch instruction with one or more instructions that do not require branching.

### SUMMARY

The present disclosure is directed to systems and corresponding methods that facilitate optimizing program code using branch elimination.

For purposes of summarizing, certain aspects, advantages, and novel features have been described herein. It is to be understood that not all such advantages may be achieved in accordance with any one particular embodiment. Thus, the claimed subject matter may be embodied or carried out in a manner that achieves or optimizes one advantage or group of advantages without achieving all advantages as may be taught or suggested herein.

In accordance with one embodiment, a method for optimizing program code is provided. The method comprises detecting a branch instruction comprising a condition expression, wherein the branch instruction, when executed by a processor, causes the processor to execute either a first set of instructions or a second set of instructions according to a value of the condition expression; and replacing the branch instruction with a third set of instructions, wherein the third set of instructions, when executed by a processor, has a collective effect same as if either the first or second set of instructions were executed according to the value of the condition expression. The third set of instructions comprises a negation instruction to normalize the value of the condition expression.

In accordance with another embodiment, a system comprising one or more logic units is provided. The one or more logic units are configured to perform the functions and operations associated with the above-disclosed methods. In accordance with yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The claimed subject matter is not, however, limited to any particular embodiment disclosed.

### BRIEF DESCRIPTION OF THE DRAWINGS

Embodiments of the claimed subject matter are understood by referring to the figures in the attached drawings, as provided below.

FIGS. 1A through 1C illustrate exemplary source codes of a program, in accordance with one embodiment.

FIG. 2 illustrates an exemplary computing environment, in accordance with one or more embodiments.

FIG. 3 is a flow diagram of a method for optimizing program code using branch elimination, in accordance with one embodiment.

FIGS. 4A and 4B illustrate exemplary source codes of a program, in accordance with one embodiment.

FIGS. 5 and 6 are block diagrams of hardware and software environments in which a system of the present invention may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXEMPLARY EMBODIMENTS

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the disclosed embodiments. The level of detail associated with each of the elements or features should not be construed to qualify the novelty or importance of one feature over the others.

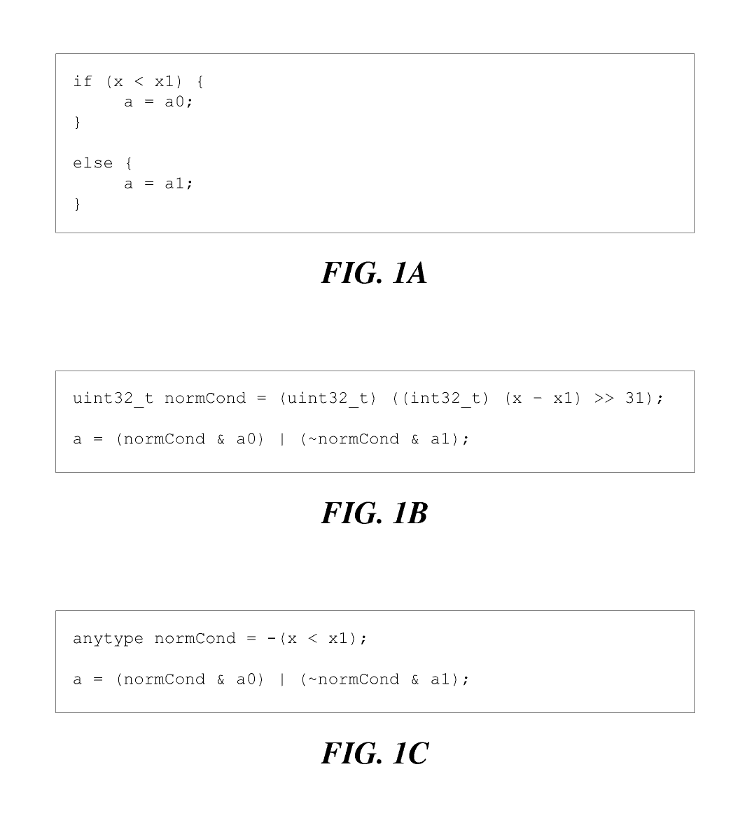

Branch elimination may be performed on a program code to improve the execution performance of a program when the program is executed. For example, the source code shown in FIG. 1A may be replaced with the source codes shown in FIG. 1B or FIG. 1C, as provided in further detail below.

Referring to FIG. 1A, an exemplary source code of a program may comprise a branch instruction including a condition expression x<xl. Depending on the value of the condition expression, the program is executed according to a different control path. If the condition expression evaluates to “true,” a first assignment instruction is executed to set a equal to a0. If the condition expression evaluates to “false,” a second assignment instruction is executed to set a equal to a1.

Referring to FIG. 1B, the source code illustrated in FIG. 1A may be optimized using branch elimination. Assuming that x is an unsigned 32-bit integer in the range 0<x<0x7fffffff, the optimized source code may comprise subtraction and bit right-shift instructions (x−xl)>>31 to normalize the value of the condition expression and an assignment instruction to set a equal to (normCond & a0)|(˜normCond & a1). It is noteworthy that the above exemplary program code, once optimized, is executable according to a single control path regardless of the value of the condition expression.

The value of the condition expression may be represented as a sequence of bits (i.e., a sequence of 0s and 1s). Normalizing the value of the condition expression causes the value to be represented as a sequence of bits in which each bit in the sequence is equal to 0 or a sequence of bits in which each bit in the sequence is equal to 1. That is, each “true” value is represented as a sequence of 1s, and each “false” value is represented as a sequence of 0s. For example, the “true” value 00001001 may be normalized to 11111111.

It is noteworthy that FIG. 1B illustrates an implementation for normalizing the value of the condition expression that is dependent on the compiler and the underlying architecture. That is, the above implementation may successfully normalize the value of the condition expression on one platform but fail to normalize the value of the condition expression on another platform. For example, the value of the condition expression may be represented as different bit sequences for certain types (e.g., “long,” double”). Thus, depending on the platform for which the program is compiled, different implementations may be needed to normalize the value of the condition expression.

Additionally, the above implementation may not be fully supported by high-level programming languages that support overloading of arithmetic operations between more complex types (e.g., classes in C++). In such a scenario, the above implementation is not always possible. Further, object-oriented programming languages may utilize object types for which a subtraction instruction is undefined.

In the following, an implementation is provided for normalizing the value of the condition expression so that x and x1 may be of any real number or object type.

Referring to FIG. 1C, in accordance with one embodiment, the optimized source code may comprise a negation instruction to normalize the value of the condition expression, in lieu of subtraction and bit right-shift instructions. A negation instruction refers to an instruction that reverses the sign of a value. For example, performing a negation instruction on the “false” value 0 returns the value 0. Performing a negation instruction on the “true” value 1 returns the value −1, which is equivalent to the binary two's complement bit sequence where each bit is equal to 1.

It is noteworthy that a negation instruction is supported by most programming languages for any real number or object type. Additionally, the above exemplary program code, once optimized, is executable according to a single control path regardless of the value of the condition expression. Further, the optimized source code retains the original syntax of the source code so that the program is easily understandable and thus easily debuggable.

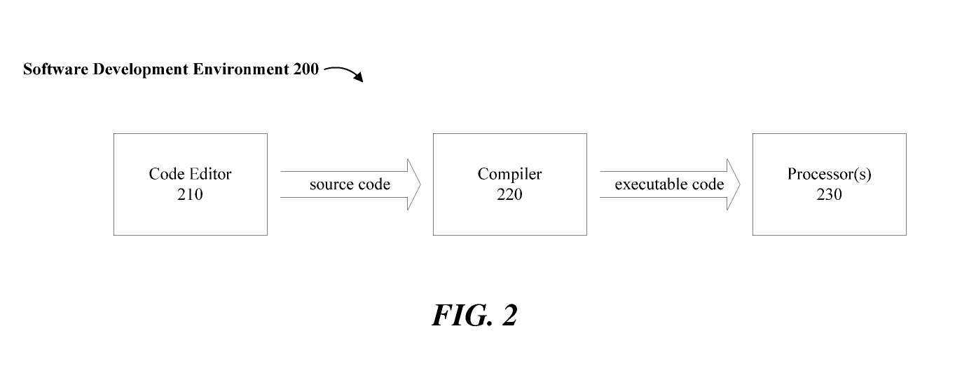

Referring to FIG. 2, in accordance with one or more embodiments, an exemplary software development environment 200 may comprise a code editor 210, a compiler 220, and one or more processors 230. The code editor 210 may be utilized to author, modify, debug, optimize, or otherwise manage a program source code. The compiler 220 may be utilized to optimize or compile the source code. Compiling refers to transforming a source code to a format that is executable by one or more processors. The processors 230 may be utilized to execute the executable code.

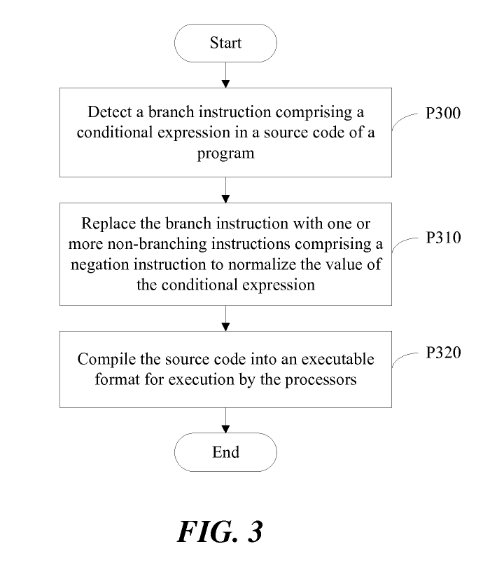

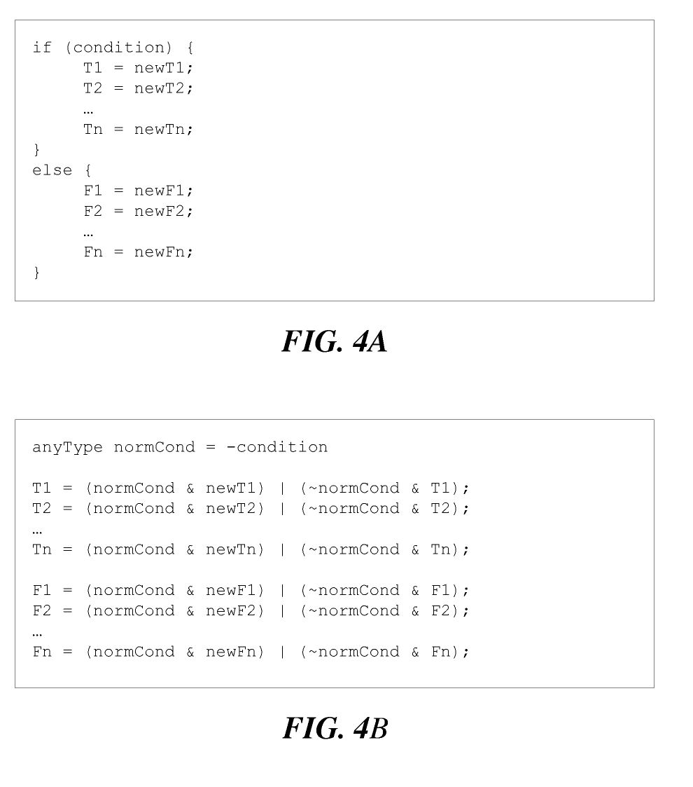

Referring to FIGS. 2, 3, 4A, and 4B, in accordance with one embodiment, a method for optimizing program code using branch elimination is provided. The compiler 220 may detect a branch instruction comprising a condition expression in the source code of a program, where the branch instruction is replaceable with one or more non-branching instructions (P300). For example, the compiler 220 may detect the branch instruction shown in FIG. 4A. In FIG. 4A, T1, . . . , Tn and F1, . . . , Fn are variables; newT1, . . . , newTn and newF1, . . . , newFn are expressions that do not include jumps to other code parts and do not have side effects (i.e., do not reference or update external data).

The branch instruction, when executed by the processors 230 may cause the processors 230 to execute either a first set of instructions or a second set of instructions according to the value of the condition expression. For example, the branch instruction shown in FIG. 4A, when executed by the processors 230, may cause the processors 230 to execute the assignment instructions T1=newT1; . . . Tn=newTn; if condition is a “true” value or the assignment instructions F1=newF1; . . . Fn=newFn; if condition is a “false” value.

Upon detecting the branch instruction, the compiler 220 may replace the branch instruction with one or more non-branching instructions, where the non-branching instructions include a negation instruction to normalize the value of the condition expression (P310). For example, the compiler 220 may replace the branch instruction shown in FIG. 4A with the non-branching instructions shown in FIG. 4B.

The non-branching instructions, when executed by the processors 230 may have a collective effect same as that of executing either the first or second set of instructions according to the value of the condition expression. For example, the non-branching instructions shown in FIG. 4B, when executed by the processors 230, may cause the processors 230 to assign the value of newT1 to T1, . . . , the value of newTn to Tn if condition is a “true” value or assign the value of newF1 to F1, . . . , the value of newFn to Fn if condition is a “false” value.

Advantageously, in a programming or execution environment where branching is not explicitly supported (e.g., gpgpu), the compiler 220 may be utilized to insert the non-branch instructions into the source code to implement branching. In an alternative embodiment, the branch instruction may be detected and replaced by a software developer utilizing the code editor 210, for example.

Once the branch instruction is detected and replaced, the compiler 220 may compile the source code into an executable format for execution by the processors 230 (P330). Replacing the branch instruction with the non-branching instructions may improve the performance of the program during execution, particularly if the branch instruction contributed to poor performance during a prior execution of the program.

Branch elimination, as provided above, is a platform-independent optimization that may be applied to a program by a software developer without utilizing a compiler. This may provide the software developer with more control over the program code execution. Further, branch elimination may be applied to a program that does not utilize compiler optimizations or to a program that utilizes a general-purpose compiler without branch elimination support.

In different embodiments, the claimed subject matter may be implemented either entirely in the form of hardware or entirely in the form of software, or a combination of both hardware and software elements. For example, the software development environment 200 may be included in a controlled computing system environment that may be presented largely in terms of hardware components and software code executed to perform processes that achieve the results contemplated by the system of the claimed subject matter.

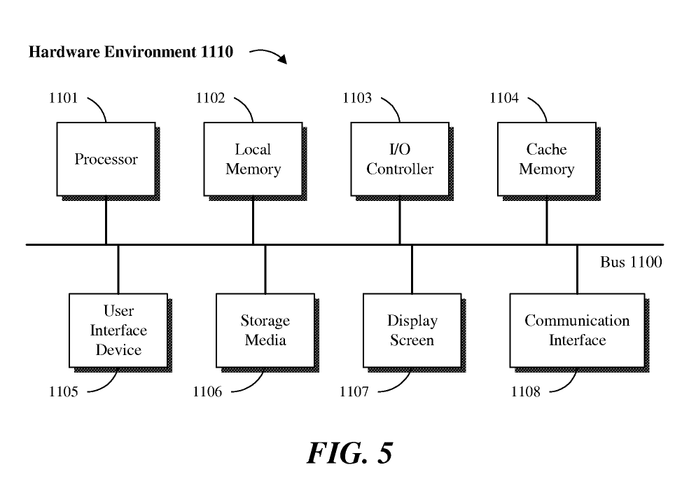

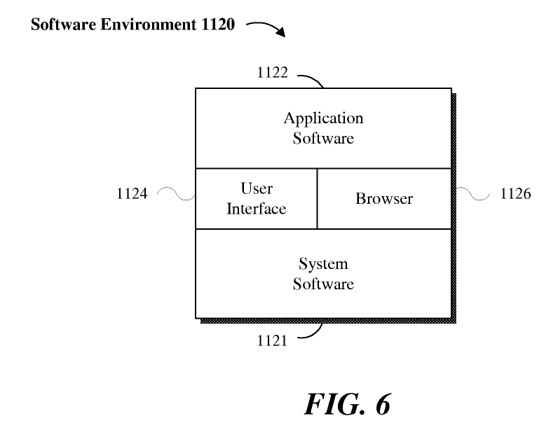

Referring to FIGS. 5 and 6, a computing system environment in accordance with an exemplary embodiment is composed of a hardware environment 1110 and a software environment 1120. The hardware environment 1110 comprises the machinery and equipment that provide an execution environment for the software; and the software environment 1120 provides the execution instructions for the hardware as provided below.

As provided here, software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. In one embodiment, the code editor 210 or the compiler 220 may be implemented as system software 1121 or application software 1122 executed on one or more hardware environments to facilitate optimizing program code using branch elimination.

System software 1121 may comprise control programs, such as the operating system (OS) and information management systems that instruct the hardware how to function and process information. Application software 1122 may comprise but is not limited to program code, data structures, firmware, resident software, microcode or any other form of information or routine that may be read, analyzed or executed by a microcontroller.

In an alternative embodiment, the claimed subject matter may be implemented as computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate or transport the program for use by or in connection with the instruction execution system, apparatus or device.

The computer-readable medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

Referring to FIG. 5, an embodiment of the application software 1122 may be implemented as computer software in the form of computer readable code executed on a data processing system such as hardware environment 1110 that comprises a processor 1101 coupled to one or more memory elements by way of a system bus 1100. The memory elements, for example, may comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 6, application software 1122 may comprise one or more computer programs that are executed on top of system software 1121 after being loaded from storage media 1106 into local memory 1102. In a client-server architecture, application software 1122 may comprise client software and server software. For example, in one embodiment, client software is executed on a personal computing system (not shown) and server software is executed on a server system (not shown).

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective processes of each method are performed are purely exemplary. Depending on implementation, the processes can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The claimed subject matter has been described above with reference to one or more features or embodiments. Those skilled in the art will recognize, however, that changes and modifications may be made to these embodiments without departing from the scope of the claimed subject matter. These and various other adaptations and combinations of the embodiments disclosed are within the scope of the claimed subject matter as defined by the claims and their full scope of equivalents.

What is claimed is:

1. A method for optimizing program code, the method comprising:
detecting a branch instruction comprising a condition expression, wherein the branch instruction, when executed by a processor, causes the processor to execute either a first set of instructions or a second set of instructions according to a value of the condition expression; and
replacing the branch instruction with a third set of instructions that are non-branching, wherein the third set of instructions, when executed by a processor, has a collective effect same as if either the first or second set of instructions were executed according to the value of the condition expression,
wherein the third set of instructions comprises a negation instruction to normalize the value of the condition expression.

2. The method of claim 1, wherein the condition expression comprises an integer.

3. The method of claim 1, wherein the condition expression comprises a real number.

4. The method of claim 1, wherein the condition expression comprises an object.

5. The method of claim 1, wherein syntax of the source code is substantially retained.

6. The method of claim 1, wherein a software developer performs the detecting of the branch instruction and the replacing of the branch instruction with the third set of instructions.

7. The method of claim 1, wherein a compiler performs the detecting the replacing of the branch instruction.

8. A system for optimizing program code, the system comprising:
a logic unit for detecting a branch instruction comprising a condition expression, wherein the branch instruction, when executed by a processor, causes the processor to execute either a first set of instructions or a second set of instructions according to a value of the condition expression; and
a logic unit for replacing the branch instruction with a third set of instructions that are non-branching, wherein the third set of instructions, when executed by a processor, has a collective effect same as if either the first or second set of instructions were executed according to the value of the condition expression,
wherein the third set of instructions comprises a negation instruction to normalize the value of the condition expression.

9. The system of claim 8, wherein the condition expression comprises an integer.

10. The system of claim 8, wherein the condition expression comprises a real number.

11. The system of claim 8, wherein the condition expression comprises an object.

12. The system of claim 8, wherein syntax of the source code is substantially retained.

13. The system of claim 8, wherein a software developer performs the detecting of the branch instruction and the replacing of the branch instruction with the third set of instructions.

14. The system of claim 8, wherein a compiler performs the detecting and the replacing of the branch instruction.

15. A computer program product comprising a computer readable medium having logic code stored thereon, wherein the logic code when executed on a computer causes the computer to:
detect a branch instruction comprising a condition expression, wherein the branch instruction, when executed by a processor, causes the processor to execute either a first set of instructions or a second set of instructions according to a value of the condition expression; and
replace the branch instruction with a third set of instructions, wherein the third set of instructions, when executed by a processor, has a collective effect same as if either the first or second set of instructions were executed according to the value of the condition expression,
wherein the third set of instructions comprises a negation instruction to normalize the value of the condition expression.

16. The computer program product of claim 15, wherein the condition expression comprises an integer.

17. The computer program product of claim 15, wherein the condition expression comprises a real number.

18. The computer program product of claim 15, wherein the condition expression comprises an object.

19. The computer program product of claim 15, wherein syntax of the source code is substantially retained.
